(19) United States
(12) Patent Application Publication
(10) Pub. No.: US 2010/0076720 A1
(43) Pub. Date: Mar. 25, 2010

(54) ORIENTATION DETECTION METHOD AND APPARATUS, AND MOVEMENT RECORD COMPUTING APPARATUS

(75) Inventors: Shinichiro MORI, Kawasaki (JP); Kyouko OKUYAMA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/533,312

(22) Filed: Jul. 31, 2009

(30) Foreign Application Priority Data
Sep. 24, 2008 (JP) 2008-244781

(51) Int. Cl. G06F 15/00

(52) U.S. Cl. 702/150

(57) ABSTRACT

An orientation detection method includes: a standard orientation determination step that detects a direction of an orientation determination element outside of a portable device with a direction detection device under the condition that a position of the portable device is fixed, and that determines the standard orientation of the portable device based on the result of the detection and the position of the portable device; and a relative angle detection step that computes a present orientation of the portable device based on both a result of a re-detection of the direction of the orientation decision element with the direction detection device and the position of the portable device after the determination of the standard orientation, and that detects an angle between the present orientation and the standard orientation.

### CROSS-REFERENCE TO RELATED APPLICATION

This application is based upon and claims the benefit of priority of the prior Japanese Patent Application No. 2008-244781, filed on Sep. 24, 2008, the entire contents of which are incorporated herein by reference.

### FIELD

A certain aspect of the embodiments discussed herein is related to an orientation detection method and apparatus, and a movement record computing apparatus.

### BACKGROUND

There has been conventionally known an art installing a triaxial acceleration sensor and a triaxial orientation sensor (a geomagnetic sensor) in a portable device such as a cell phone, correcting a geomagnetic value detected by the orientation sensor based on an inclined angle of the portable device calculated from an output of the acceleration sensor, and computing the orientation with the corrected value, as is disclosed in Japanese Laid-open Patent Publication Nos. 08-278137 and 2004-286732.

According to the art disclosed in Japanese Laid-open Patent Publication Nos. 08-278137 and 2004-286732, the orientation sensor is horizontally installed to the portable device, and a program for outputting the orientation (an orientation output program) outputs the orientation to which a reference position 510 of a portable device 500 illustrated in FIG. 9A is heading.

More specifically, when the reference position 510 (a head position) of the portable device 500 heads north as illustrated in FIG. 9A, the orientation output program outputs “north” which is to say “0°”. When the portable device 500 is inclined at an angle of δ degrees to a horizontal surface as illustrated in FIG. 9B, the orientation output program outputs the orientation indicated by the horizontal component of the orientation to which the portable device 500 is heading. That is to say, the orientation output program outputs the orientation “north” or the angle “0°” also in the case illustrated in FIG. 9B.

### SUMMARY

According to an aspect of the present invention, there is provided an orientation detection method including: detecting a direction of an orientation determination element outside of a portable device with a direction detection device under the condition that a position of the portable device is fixed; determining a standard orientation of the portable device based on the result of the detection and the position of the portable device; computing a present orientation of the portable device based on both a result of a re-detection of the direction of the orientation decision element with the direction detection device and the position of the portable device after the determination of the standard orientation; and detecting an angle between the present orientation and the standard orientation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating schematically configurations of a cell phone in accordance with an exemplary embodiment of the present invention and a movement record computing apparatus that the cell phone contains;

FIG. 2 is a flowchart illustrating procedures of a movement record computing apparatus;

FIG. 3 is a flowchart illustrating procedures of step S12 in FIG. 2;

FIG. 4 is an explanatory diagram explaining a roll angle and a pitch angle;

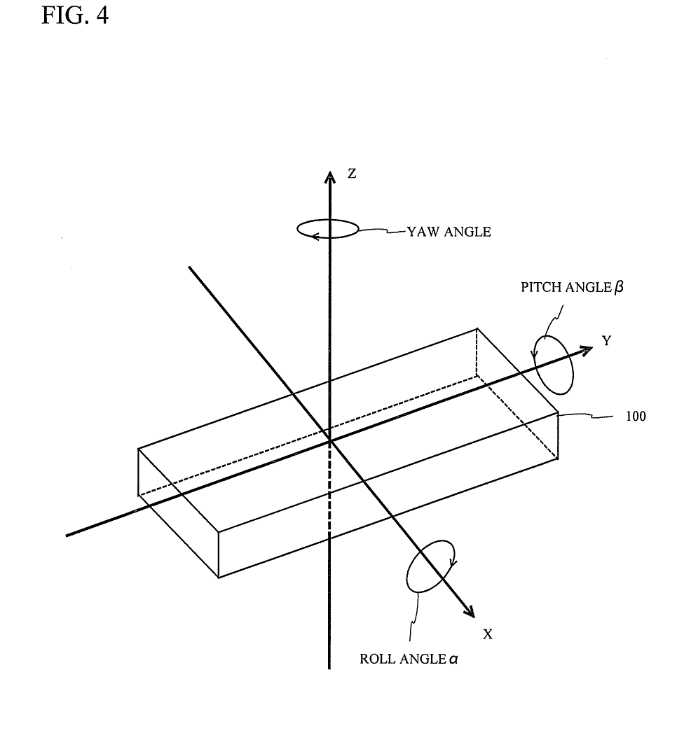

FIGS. 5A through 5C are explanatory diagrams explaining a method to calculate an orientation vector;

FIG. 6 is a flowchart illustrating procedures of step S14 in FIG. 2;

FIG. 7 is an explanatory diagram explaining a method to calculate a relative azimuth;

FIGS. 8A through 8D illustrate movement records acquired by a process in FIG. 2; and

FIGS. 9A through 9C illustrate a related art.

### DESCRIPTION OF EMBODIMENTS

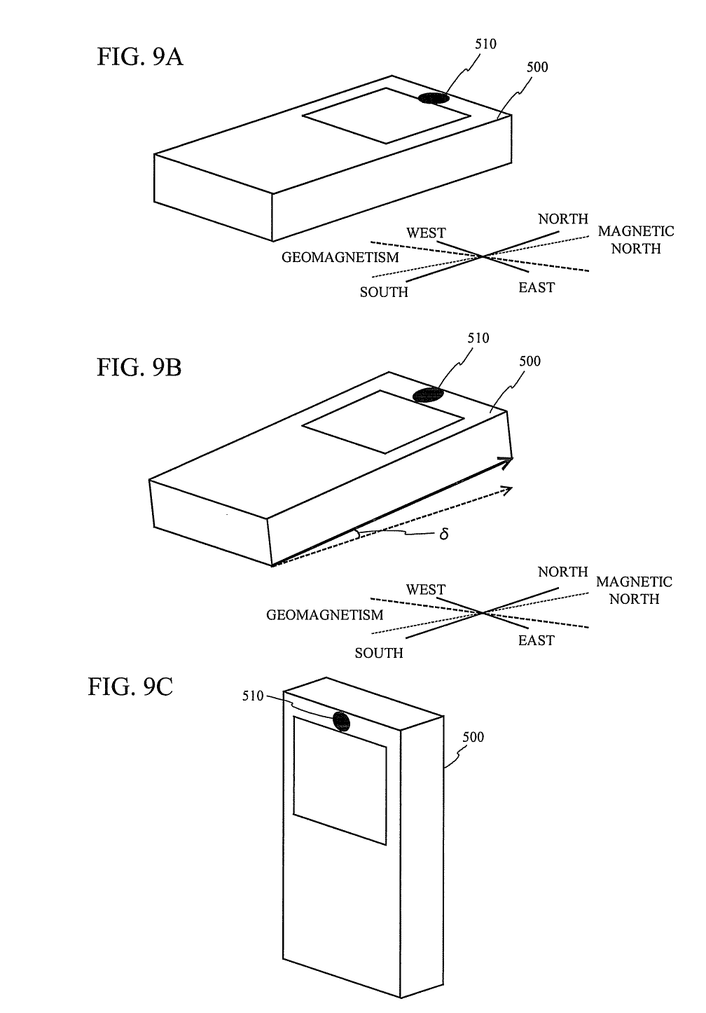

As described above, according to related arts, when the portable device 500 is inclined at an angle of δ degrees to a horizontal surface as illustrated in FIG. 9B, the orientation output program outputs the orientation indicated by the horizontal component of the orientation to which the portable device 500 is heading. That is to say, the orientation output program outputs the orientation “north” or the angle “0°” also in the case illustrated in FIG. 9B.

Therefore, when the reference position (the head position) of the portable device heads to a vertical direction that is to say straight up and down directions, the orientation output program of related arts cannot output the orientation or the angle because the horizontal component of the reference position of the portable device does not exist.

For example, when a user carrying the portable device moves (walks) for a long time, the user moves holding the portable device in a device holder mounted to his or her waist or in his or her pocket more often than holding the portable device in his or her hand. However, if the related arts are simply applied, the orientation and the angle cannot be outputted, because the portable device in the holder or in the pocket often heads straight up and down.

It is also possible to acquire the user's movement record with a GPS function when the GPS function is implemented to the portable device. However, in this case, it is required to make the GPS function work all the time or at arbitrary short time interval. Therefore, using the GPS function is an unsuitable method for acquiring the movement record for a long time because it consumes relatively high electrical power. Then, a method for acquiring the movement record of the user carrying the portable device by acquiring changes in the orientation of the movement direction of the device acquired by the orientation output program like related arts is thought. But as described above, it is difficult to acquire the user's movement record, because the orientation output program according to the related arts cannot output the orientation and the angle when the portable device is in the pocket or in the device holder.

A description will now be given of embodiments of the present invention with reference to the accompanying drawings.

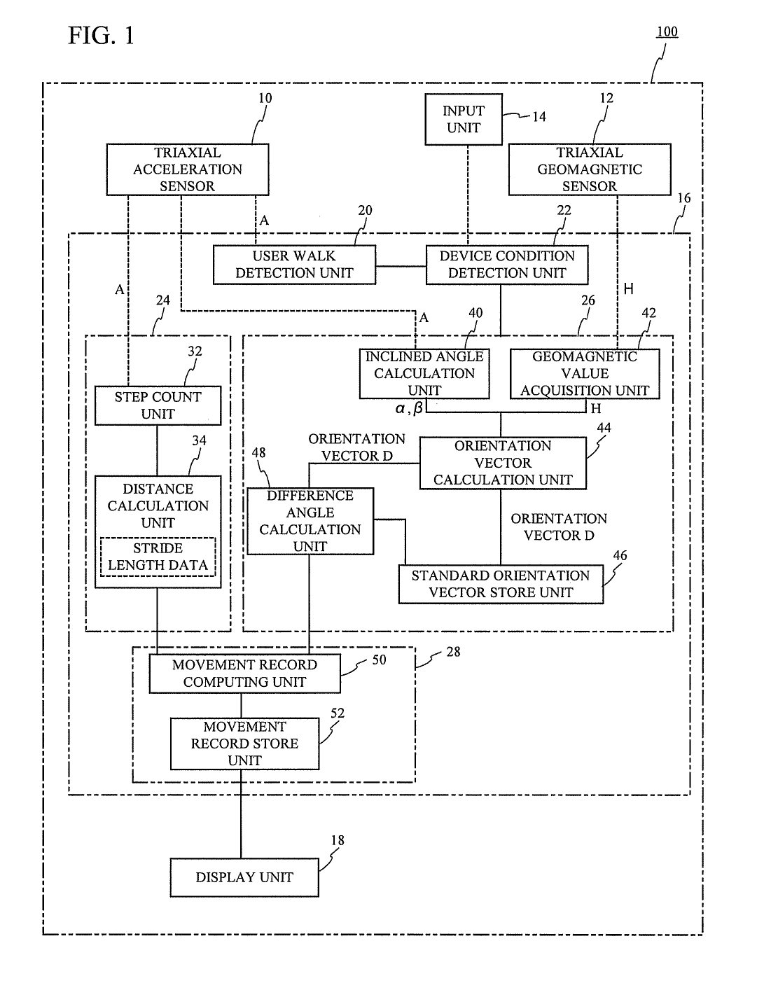

A configuration of a cell phone 100 in accordance with an embodiment of the present invention is illustrated with a block diagram in FIG. 1. As illustrated in FIG. 1, the cell phone 100 includes a triaxial acceleration sensor 10, a triaxial geomagnetic sensor 12 as a direction detection device, an input unit 14, a movement record computing apparatus 16, and a display unit 18.

The triaxial acceleration sensor 10 detects accelerations of triaxial directions. An acceleration value A detected by the triaxial acceleration sensor 10 is outputted to the movement record computing apparatus 16 (a user walk detection unit 20, a step count unit 32, and a inclined angle calculation unit 40).

A magnetic orientation sensor, which can detect a geomagnetic value in the triaxial reference system, is used as the triaxial geomagnetic sensor 12. The geomagnetic value H detected by the triaxial geomagnetic sensor 12 is outputted to the movement record computing apparatus 16 (a geomagnetic value acquisition unit 42 ).

The input unit 14 includes input buttons and touch panels, and instructions from users are inputted via the input unit 14. The instructions from the users in this embodiment contain setting/cancellation of the movement record acquisition mode.

The movement record computing apparatus 16 includes the user walk detection unit 20, a device condition detection unit 22, a movement distance measurement device 24, an orientation detection apparatus 26, and a movement record computing and a store device 28.

The user walk detection unit 20 detects whether or not the user is walking based on the acceleration value A input from the triaxial acceleration sensor 10. This is disclosed in Japanese Laid-opened Patent Publication No. 2008-171347.

The device condition detection unit 22 detects whether or not the mode to acquire the movement record (the movement record acquisition mode) is set. In this embodiment, the user sets the movement record acquisition mode via the input unit 14. Thus, the device condition detection unit 22 determines whether the movement record acquisition mode is set or not by detecting the input from the user.

The movement distance measurement device 24 includes the step count unit 32 as a step detection unit, and a distance calculation unit 34.

The step count unit 32 counts the number of the user's step based on the acceleration value A input from the triaxial acceleration sensor 10 as an ordinal pedometer counts. This is disclosed in Japanese Laid-opened Patent Publication No. 2008-171347 mentioned before. The distance calculation unit 34 stores a stride length preliminarily inputted by the user via the input unit 14, and calculates the movement distance by multiplying the stride length by the number of the step counted by the step count unit 32. This calculation result by the distance calculation unit 34 is outputted to the movement record computing and store device 28.

The orientation detection apparatus 26 includes an inclined angle calculation unit 40, a geomagnetic value acquisition unit 42, an orientation vector calculation unit 44 as an orientation computing unit, a standard orientation vector store unit 46, and a difference angle calculation unit 48 as a relative angle calculation unit.

The inclined angle calculation unit 40 calculates an inclined angle based on the acceleration input from the triaxial acceleration sensor 10. A calculation method of the inclined angle is described below.

The geomagnetic value acquisition unit 42 acquires the geomagnetic value H input from the triaxial geomagnetic sensor 12.

The orientation vector calculation unit 44 calculates an orientation vector D with the inclined angle of the cell phone 100 calculated by the inclined angle calculation unit 40 and the geomagnetic value H acquired by the geomagnetic value acquisition unit 42. A calculation method of the orientation vector is described below.

The standard orientation vector store unit 46 stores one of the orientation vector D as “the standard orientation vector”.

The difference angle calculation unit 48 calculates the angle between the standard orientation vector, which is stored in the standard orientation vector store unit 46, and another orientation vector (a relative orientation), and outputs it to the movement record computing and store device 28.

The movement record computing and store device 28 includes the movement record computing unit 50 and the movement record store unit 52.

The movement record computing unit 50 computes the movement record with the movement distance of the user calculated by the distance calculation unit 34 and the relative orientation calculated by the difference angle calculation unit 48. In this case, the movement record information such as “moved q meter to the p+ direction from the standard orientation” is computed. This computing result is sent to the movement record store unit 52, and the movement record store unit 52 acquires and stores the movement record.

The display unit 18 contains a liquid crystal display or an organic light emitting display, and displays the movement record stored in the movement record store unit 52 according to a display instruction from the user. The display unit 18 displays various information to fulfill various functions that the cell phone 100 has.

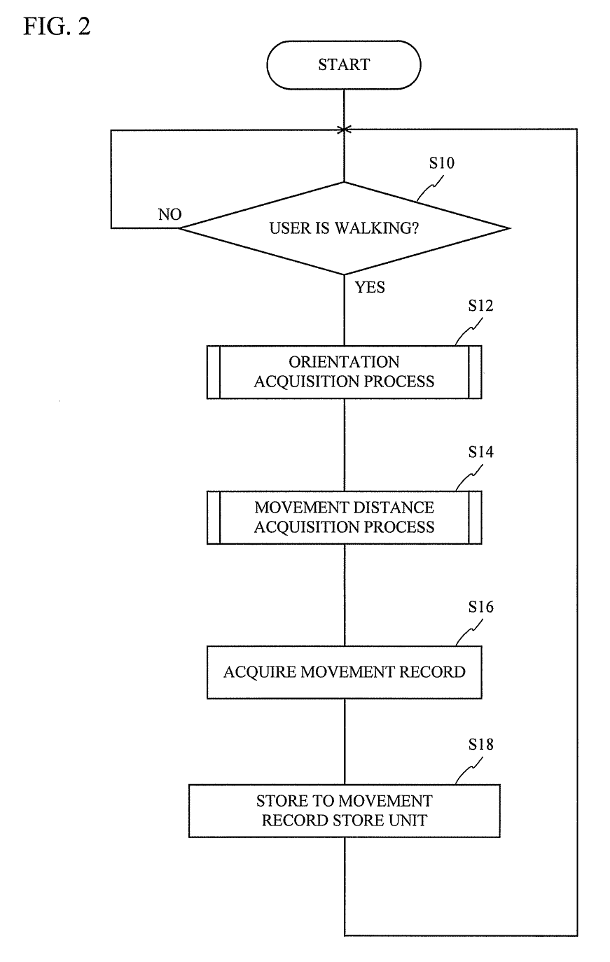

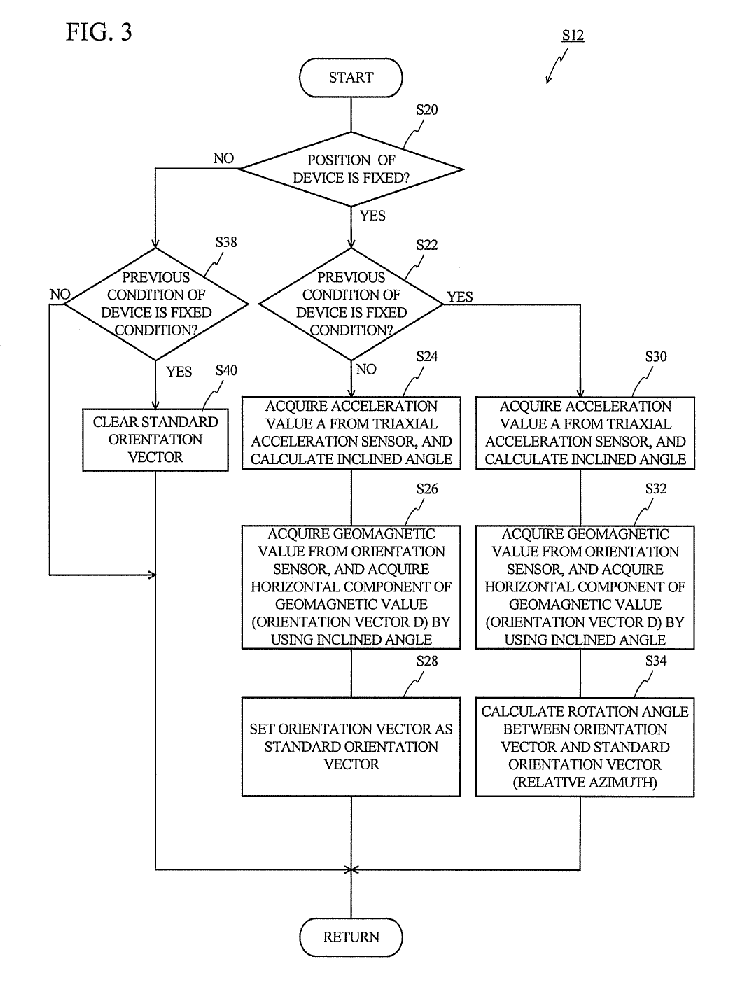

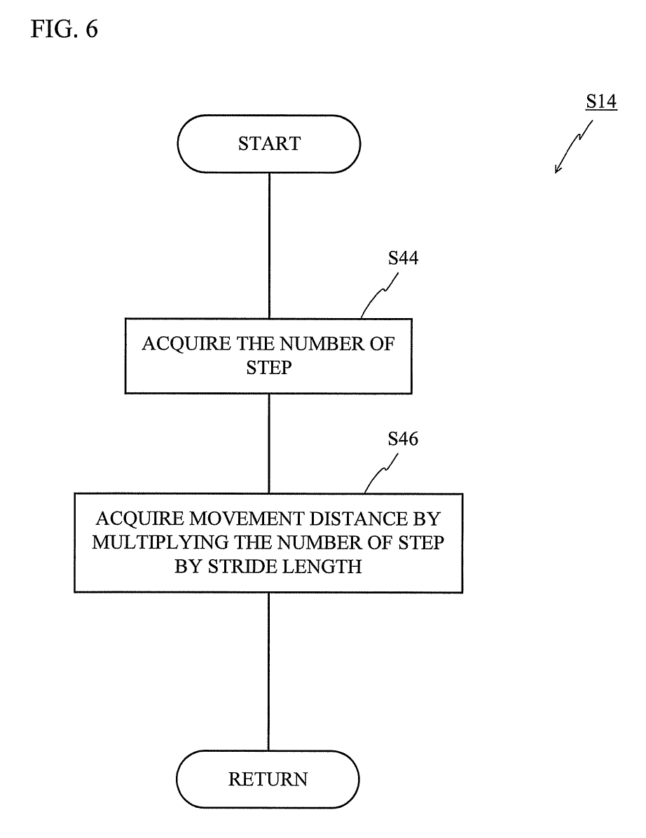

Now the description of the specific process that the movement record computing apparatus 16 configured as described above executes will be given referring to flowcharts illustrated in FIG. 2, FIG. 3, and FIG. 6, and other drawings.

In the step S10 in FIG. 2, the user walk detection unit 20 determines whether or not the user is walking based on the acceleration value A input from the triaxial acceleration sensor 10. And the process goes to the step S12 only when the user walk detection unit 20 determines that the user is walking.

In the step S12, a subroutine of the orientation acquisition process is executed. In this subroutine of the orientation acquisition process, the device condition detection unit 22 determines whether the position of the device (the cell phone 100) is fixed in the step S20 as illustrated in FIG. 3. In this embodiment, as described above, the device condition detection unit 22 determines the fixed condition when it detects the input from the user and determines that the movement record acquisition mode is set. After the fixed condition is determined, the fixed condition is locked till the user cancels the movement record acquisition mode.

When the determination of the step S20 is YES, the process goes to the step S22 and the device condition detection unit 22 determines whether the previous condition of the cell phone 100 was the fixed condition. When the determination of the step S22 is NO, the process goes to the step S24, and the inclined angle calculation unit 40 acquires the acceleration value A from the triaxial acceleration sensor 10 and calculates the inclined angle. When the inclined angle is calculated, an X-Y-Z coordinate system, of which an X-Y coordinate system is a virtual horizontal surface that is parallel to a ground, is set. In this case, both axes of X and Y can face in any direction if they are at right angles to each other.

The acceleration value A acquired by the triaxial acceleration sensor is expressed in the following formula (1).

$$A = [ \begin{matrix}{a}_{x} \\ {a}_{y} \\ {a}_{z}\end{matrix} ] \qquad ( 1 )$$

Thus, define gravity acceleration as g, and a gravity vector G as the following formula (2).

$$G = [ \begin{matrix}\begin{matrix}0 \\ 0\end{matrix} \\ - g\end{matrix} ] \qquad ( 2 )$$

Set the X-Y-Z coordinate system, of which the X-Y coordinate system is a virtual horizontal surface that is parallel to the ground, to the cell phone 100. When the inclined angles with respect to the horizontal surface of the cell phone 100 are defined as a pitch angle β and a roll angle α, the relationship among A, G, β and α is expressed in the following formula (3).

$$[ \begin{matrix}{a}_{x} \\ {a}_{y} \\ {a}_{z}\end{matrix} ] = g [ \begin{matrix}\begin{matrix}sin ( β ) \\ - cos ( β ) sin ( α )\end{matrix} \\ - cos ( β ) cos ( α )\end{matrix} ] \qquad ( 3 )$$

According to the formula (3), the pitch angle β and the roll angle α are expressed in the following formulas (4) and (5).

$$\begin{matrix}β = arc sin ( \frac{{a}_{x}}{g} ) & ( 4 ) \\ α = arc sin ( \frac{{a}_{y}}{- g cos ( β )} ) & ( 5 )\end{matrix}$$

By using the formulas above, in the step S24, the inclined angle (the pitch angle β and the roll angle α) can be calculated.

In the next step S26, the geomagnetic value acquisition unit 42 acquires the geomagnetic value H, which is expressed in the following formula (6), from the triaxial geomagnetic sensor 12.

$$H = [ \begin{matrix}\begin{matrix}{H}_{x} \\ {H}_{y}\end{matrix} \\ {H}_{z}\end{matrix} ] \qquad ( 6 )$$

The orientation vector calculation unit 44 acquires the horizontal component of the geomagnetic value H (the orientation vector D) with the inclined angles β and α calculated in the step S24.

More specifically, the orientation vector calculation unit 44 corrects the geomagnetic value H with the inclined angle P and a according to the following formula (7) and acquires the corrected geomagnetic value H′.

$$[ \begin{matrix}\begin{matrix}{H}_{x}^{′} \\ {H}_{y}^{′}\end{matrix} \\ {H}_{z}^{′}\end{matrix} ] = [ \begin{matrix}cos β & 0 & - sin β \\ 0 & 1 & 0 \\ sin β & 0 & cos β\end{matrix} ] [ \begin{matrix}1 & 0 & 0 \\ 0 & cos α & sin α \\ 0 & - sin α & cos α\end{matrix} ] [ \begin{matrix}{H}_{x} \\ {H}_{y} \\ {H}_{z}\end{matrix} ] \qquad ( 7 )$$

The component in the horizontal surface of this corrected geomagnetic field H′ is defined as the orientation vector D expressed in the following formula (8).

\vec{D}=(x0,y0)=(Hₓ′,H_{y}′) (8)

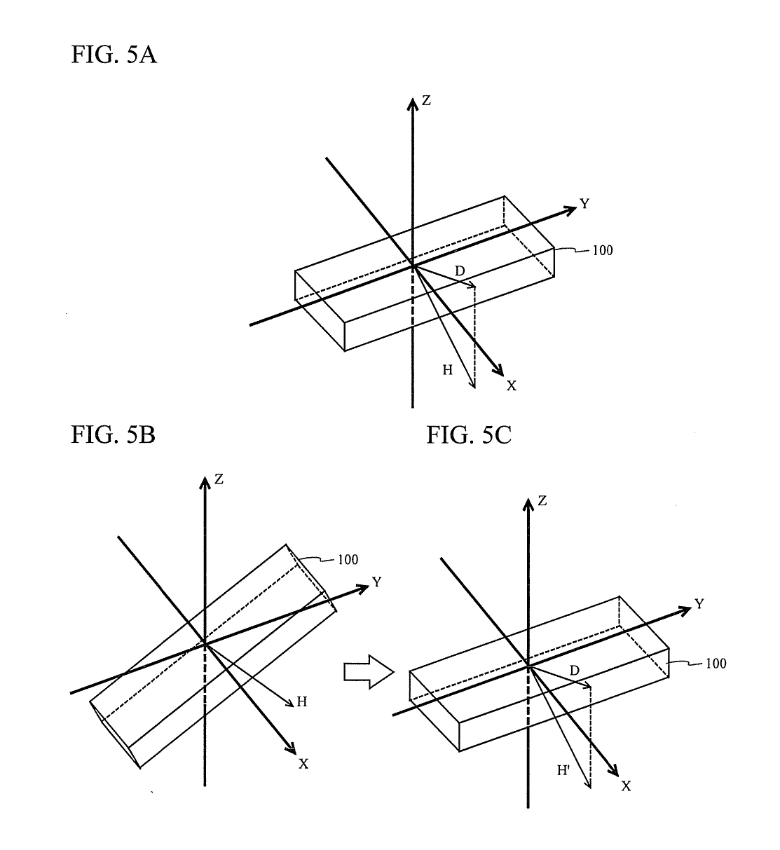

In this case, for example, as illustrated in the FIG. 5A, when the roll angle a and the pitch angle β are 0°, in the X-Y-Z coordinate system, of which the X-Y coordinate system is the virtual horizontal surface that is parallel to the ground, the cell phone 100 becomes parallel to the X-Y plane and the vector of the geomagnetic value H simply projected onto the horizontal surface becomes the orientation vector D. Meanwhile, when the cell phone 100 is inclined to the horizontal surface as illustrated FIG. 5B, the vector that is the projection onto the horizontal surface of the corrected geomagnetic value H′ that is calculated by correcting the geomagnetic value H to be parallel to the virtual horizontal surface that is parallel to the ground with the inclined angles (the roll angle and the pitch angle) of the cell phone 100 becomes the orientation vector D as illustrated in FIG. 5C.

Back to FIG. 3, in the next step S28, the orientation vector D acquired in the step S26 is set as the standard orientation vector D0.

When the standard orientation vector D0 is determined as described above, the process goes to the step S14 in FIG. 2. In this step S14, the movement distance acquisition processing subroutine is executed.

In this movement distance acquisition processing subroutine, in the step S44 of FIG. 6 the step count unit 32 acquires the number of the step based on the output from the triaxial acceleration sensor 10 (the acceleration value A), and in the step S46 the distance calculation unit 34 calculates the movement distance by multiplying the number of the step by the stride length preliminarily input by the user. When the movement distance is calculated, the process goes to the step S16 in FIG. 2.

In the step S16 of FIG. 2, the movement record computing unit 50 acquires the movement record. In this case, the movement record computing unit 50 acquires the movement record such as “moved q meter to the 0° direction from the standard orientation” based on the standard orientation vector (D0) determined in the step S28 of FIG. 3 and the movement distance.

Then, in the step S18, the movement record that the movement record computing unit 50 acquires in the step S16 is stored in the movement record store unit 52, and the process returns to the step S10.

When the determination in the step S10 is YES, the orientation acquisition processing subroutine in the step S12 is reexecuted. In this subroutine, when the determination in the step S20 is YES (because the fixed condition is locked in the cell phone 100), in the step S22 whether the previous condition of the device was the fixed condition is determined.

In this case, the determination in the step S22 is YES because the previous condition of the device was the fixed condition, and the process goes to the step S30. In this step S30, the inclined angle calculation unit 40 acquires the acceleration value A from the triaxial acceleration sensor 10 and calculates the inclined angle (α, β) on the X-Y-Z coordinate system set in the step S24, with the same method as the step S24 described above. In the step S32, the geomagnetic value acquisition unit 42 acquires the geomagnetic value H from the triaxial geomagnetic sensor 12 and acquires the horizontal component of the geomagnetic value H (the corrected geomagnetic value H′) (the orientation vector D) by using the inclined angle (α, β) calculated in the step S30, with the same method as the step S26 described above.

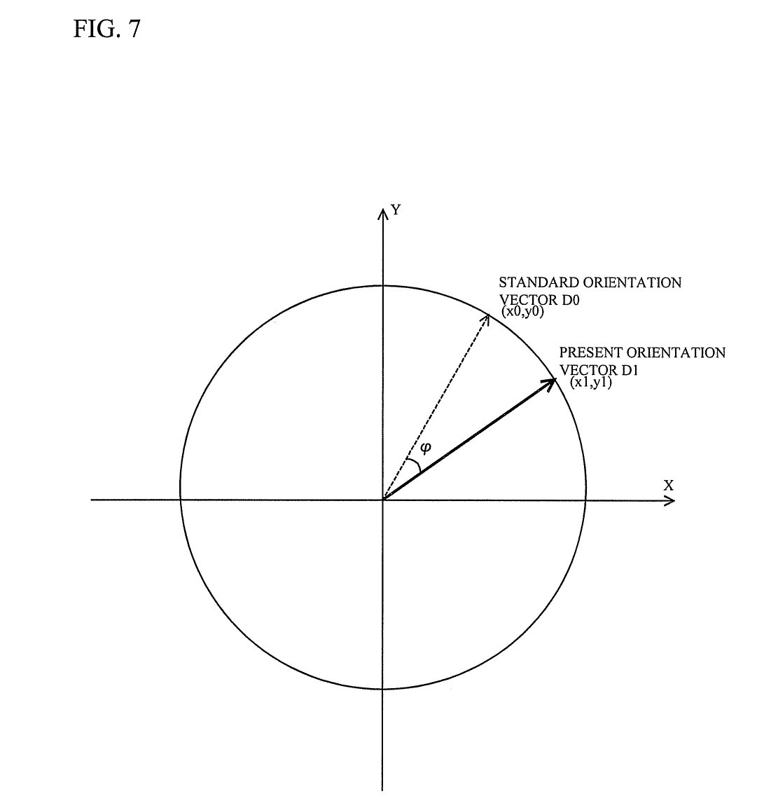

Then, in the step S34, the difference angle calculation unit 48 calculates the angle between the orientation vector D acquired in the step S32 (hereinafter called “the present orientation vector D1”) and the standard orientation vector D0 (the relative azimuth of the present orientation vector D1 by reference to the standard orientation vector D0) as described below. In the FIG. 7, a symbol φ expresses the angle between the present orientation vector D1 and the standard orientation vector D0 (the relative azimuth).

Define the standard orientation vector and the present orientation vector as D0=(x0, y0) and D1=(x1, y1) respectively. Then, an outer product of the vectors D0 and D1 and an inner product of the vectors D0 and D1 are expressed in the following formulas (9) and (10).

inner product=(x0*y1)−(y0*x1) (9)

outer product=(x0*x1)+(y0*y1) (10)

Therefore, the relative azimuth φ is calculated with the following formula (11).

φ=arctan((x0*y1−y0*x1)/(x0*x1+y0*y1)) (11)

Accordingly, in the step S34, the relative azimuth φ is calculated with the formula (11), and the process goes to the step S14 in FIG. 2. In this step S14, the movement distance acquisition processing subroutine is executed as described above. In the next step S16, the movement record computing unit 50 acquires the movement record. In this step S16, the movement record computing unit 50 acquires the movement record such as “moved q′ meter to the φ° direction from the standard orientation” based on the relative azimuth φ decided in the step S34 of the FIG. 3 and the movement distance acquired in the step S14.

Then, in the step S18, the movement record computing unit 50 sends the movement record acquired in the step S16 to the movement record store unit 52, and the process returns to the step S10.

The loop, which is the step S10→the step S12 (the step S20→S22→S30→S32→S34 in FIG. 3)→the step S14 (the step S44→S46 in FIG. 6)→the step S16→the step S18 in the FIG. 2, is repeatedly executed at specified time intervals that is shorter than the average time of a step a human takes (e.g. from 400 msec to 500 msec). The processing order of the step S12 and the step S14 can be changed and the step S12 can be executed after the step S14.

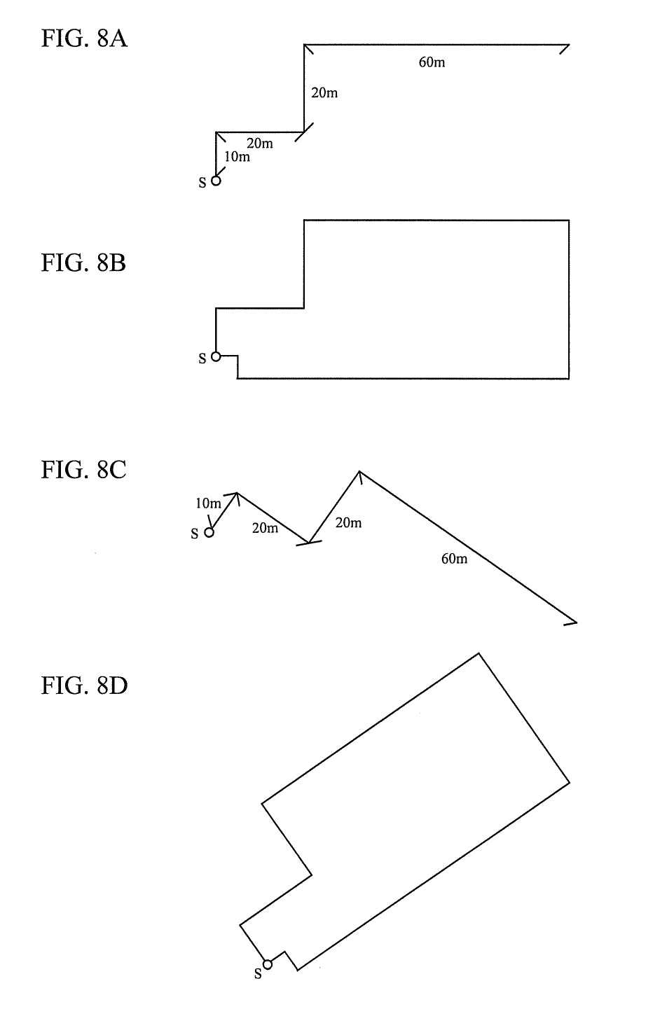

Both the migration pathway after starting to move from the starting post S and the movement distance can be acquired by integrating (combining) the movement records acquired with the process described above as illustrated in FIG. 8A. Additionally, it is possible to know that the user starts moving from the starting post S and comes back to the starting post S as illustrated in FIG. 8B. Furthermore, according to FIG. 8B, it is possible to detect how many times an athlete having the cell phone 100 or the mobile device that contains the movement record computing apparatus 16 goes around a track of an athletic stadium. The movement record can be displayed on the display unit 18 when the user operates the input unit 14 and executes the display process of the movement record, or when the user terminates the movement record acquisition mode.

In this embodiment, the migration pathway that is the turned migration pathway illustrated in FIGS. 8A and 8B may be acquired as illustrated in FIGS. 8C and 8D depending on the standard orientation vector decided first. However, it is easy to correct the migration pathway illustrated in FIGS. 8C and 8D to the migration pathway illustrated in FIGS. 8A and 8B by associating the standard orientation vector with the absolute orientation separately input by the user or the map data (adapting to a road). Furthermore, whether or not the user comes back to the starting post can be checked without any problem even though the absolute orientation is not settled.

When the fixed condition of the cell phone 100 is released (when the set of the movement record acquisition mode is cancelled), the determination in the step S20 (FIG. 3) of the step S12 (the orientation acquisition processing subroutine) is NO and the process goes to the step S38.

In this step S38, whether the previous condition was the fixed condition is determined. When the determination in the step S38 is YES, the standard vector D0 is cleared in the step S40. Additionally, the X-Y-Z axis set in the step S24 is cleared. When the determination in the step S38 is NO, the process goes to the step S14, and waits until the cell phone 100 becomes the fixed condition (until the movement record acquisition mode is set).

In this embodiment, instead of an X-Y-Z axis fixed to the device, an X-Y-Z axis of which an X-Y coordinate system is the virtual horizontal surface that is parallel to the ground is set each time the standard orientation vector is calculated. The process to compute the orientation with the inclined angle (the pitch angle, the roll angle) is executed by assuming the condition that the device rotates in the axis. Therefore, it is possible to calculate the relative azimuth φ based on the standard orientation vector regardless of the position of the cell phone 100. The X-Y axis set when the standard orientation vector is calculated can be the axis that directs a different orientation every time if the X-Y plane is the virtual surface that is parallel to the ground. For example, it is allowed that an X axis may be set to the magnetic north when the standard orientation vector is calculated first and an X axis may be set to east inclined 30 degree from the magnetic north, which is a different orientation from the orientation of the X axis set first when the standard orientation vector is calculated a second time.

As described in detail above, according to this embodiment, the standard orientation vector D0 of the cell phone 100 is determined based on the result of the geomagnetic detection (the geomagnetic value H) by the triaxial geomagnetic sensor 12 and the position of the cell phone 100 (the roll angle α, the pitch angle β) under the condition that the position of the cell phone 100 is fixed. After that, the angle between the present orientation vector D1 of the cell phone 100, which is calculated based on the result of the geomagnetic re-detection (the geomagnetic value H) by the triaxial geomagnetic sensor 12 and the position of the cell phone 100 (the roll angle α, the pitch angle β), and the standard orientation vector D0 (the relative azimuth) φ is detected. Therefore, regardless of the position of the cell phone 100, the relative angle of the cell phone 100 by reference to the standard orientation vector D0 can be detected. It means that with the known arts, the orientation cannot be measured when the cell phone 100 of which the reference position is the top of the device points to the vertical direction as illustrated in FIG. 10C, because the known arts determine the reference position in the cell phone and measure the orientation with the absolute orientation (the orientation which expressed by four cardinal points or the angle based on the north) in the reference position. But, as described in this embodiment, the relative angle to the standard orientation vector D0 can be always calculated by using the relative azimuth regardless of the position of the cell phone 100.

Additionally, according to this embodiment, the movement record computing is easy because the user's movement record is computed based on the angle between the standard orientation vector D0 and the present orientation vector D1 of the cell phone 100 (the relative azimuth) φ and the number of a user's step. In this case, power consumption can be reduced because the device such as GPS is not used (the triaxial geomagnetic sensor and the triaxial acceleration sensor are used).

Although in the above embodiment the determination in the step S20 of FIG. 3 is made based on the user's input (setting of the movement record acquisition mode), it can be made based on other ways not limited to this embodiment. For example, the fixed condition can be determined by detecting the change of the output value per unit time of the triaxial acceleration sensor 10 and determining whether the change is equal or less than the threshold value. Or by detecting the start of walking with the step count unit 32 the fixed condition can be determined after the user starts walking.

Additionally, for example, the fixed condition can be determined when the condition of the cell phone 100 becomes the condition described below, and after that the fixed condition is locked (kept) till the user takes a cancel action. The fixed condition may be determined, for example; (1) when the change of the geomagnetic value per unit time is equal or less than the threshold value; (2) when the change of the output value from the acceleration sensor per unit time is equal or less than the threshold value; (3) when the condition that the change of the geomagnetic value per unit time is equal or less than the threshold value continues for more than a certain period of time; (4) when the start of walk is detected (when the step count unit 32 outputs the number of the step); (5) when the start of walk is detected and the change of the geomagnetic value per unit time is equal or less than the threshold value; or (6) when the start of walk is detected and the condition that the change of the geomagnetic value per unit time is equal or less than the threshold value continues for more than a certain period of time.

The element to determine the orientation is not limited to this embodiment although the case to use the geomagnetism as the element to determine the orientation is described in the above embodiment. For example, radio waves transmitted by a radio wave transmitter or infrared rays transmitted by an infrared ray transmitter can be used as the element to decide the orientation. In this case, for example, by mounting the orientation detection device and the movement record calculation device of the present invention on a self-propelled robot, the movement record and the movement direction (the relative azimuth based on the standard orientation) of the robot can be acquired. According to this case, a control of the robot can be easily done with the movement record and the movement direction acquired.

Although in the above embodiment the case that the movement record computing apparatus of the present invention is mounted on the cell phone 100, it is possible to mount the movement record computing apparatus on other mobile device such as a PDA (Personal Digital Assistant) and a smart phone. Additionally, although in the above embodiment the movement record computing apparatus contains the orientation detection device 26 and the movement distance measurement device 24 that measures movement distance based on the number of the step, the configuration of the movement record computing apparatus is not limited to the above embodiment. For example, the movement record computing apparatus can be composed of the orientation detection apparatus 26 and a car-mounted meter device that can acquire the movement distance.

The orientation detection device and the movement record computing apparatus in the above embodiment can be composed of a combination of a plurality of devices that are corresponding to each unit in FIG. 1. Also each device can be composed of a computer system composed of a combination of a CPU, a ROM and a RAM, and functions that each unit above has are carried out with a program implemented in the computer system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various change, substitutions, and alterations could be made hereto without departing from the spirit and scope of the invention.

What is claimed is:

1. An orientation detection method comprising:
detecting a direction of an orientation determination element outside of a portable device with a direction detection device under the condition that a position of the portable device is fixed;
determining a standard orientation of the portable device based on the result of the detection and the position of the portable device;
computing a present orientation of the portable device based on both a result of a re-detection of the direction of the orientation decision element with the direction detection device and the position of the portable device after the determination of the standard orientation; and
detecting an angle between the present orientation and the standard orientation.

2. The orientation detection method according to claim 1, wherein the detecting includes detecting the position of the portable device with a triaxial acceleration sensor that the portable device contains; and the determining includes computing a component in a virtual surface, which is parallel to a ground, of a direction of the orientation determination element detected with the direction detection device based on the position of the portable device detected with the triaxial acceleration sensor, and setting the component in the virtual surface as the standard orientation.

3. The orientation detection method according to claim 1, wherein the computing includes detecting a present position of the portable device with a triaxial acceleration sensor that the portable device contains, calculating a component in a virtual surface, which is parallel to a ground, of a direction of the orientation decision element based on the present position of the portable device detected with the triaxial acceleration sensor, and setting the component in the virtual surface as the present orientation.

4. The orientation detection method according to claim 1, wherein the orientation decision element is geomagnetism, and the direction detection device is a triaxial geomagnetic sensor.

5. The orientation detection method according to claim 1, wherein the determining includes determining whether or not the position of the portable device is fixed, based on at least one of a user input, change of detection values by the direction detection device, and change of the position of the portable device.

6. The orientation detection method according to claim 1, further comprising determining whether or not the relative angle detection step is executed, based on at least one of a user input and change of the position of the portable device.

7. An orientation detection apparatus comprising:
an inclined angle calculation unit that calculates a position of a portable device;
an orientation computing unit that computes an orientation of the portable device based on the result in the detection of a direction of a orientation detection element outside of the portable device with a direction detection device that the portable device contains; and
a relative angle calculation unit that decides a standard orientation of the portable device based on the calculation result of the orientation computing unit, and calculates an angle between the orientation of the portable device after the decision of the standard orientation and the standard orientation.

8. The orientation detection apparatus according to claim 7, wherein the inclined angle calculation unit calculates a position of the portable device based on the result of the detection by a triaxial acceleration sensor that the portable device contains, and the orientation computing unit computes a component in a virtual surface, which is parallel to a ground, of a direction of the orientation decision element detected by the direction detection device based on the position of the portable device, and sets the component in the virtual surface of the portable device as an orientation of the portable device.

9. The orientation detection apparatus according to claim 7, wherein the orientation detection element is a geomagnetism, and the direction detection device is a triaxial geomagnetic sensor.

10. The orientation detection apparatus according to claim 7, further comprising a device condition detection unit that detects a timing to determine the standard orientation of the portable device by the relative angle calculation unit based on at least one of a user's input, change of detection values of the direction detection device and change of the position of the portable device.

11. A movement record computing apparatus comprising:
an orientation detection unit that determines a standard orientation of a portable device, and detects an angle between a present orientation of the portable device and the standard orientation;
a step detection unit that detects the number of user's step; and
a movement record computing unit that computes the movement record of the user based on the result of the detection by the orientation detection unit and the result of the detection by the step detection unit.

12. The movement record computing apparatus according to claim 11, wherein the orientation detection unit includes: an inclined angle calculation unit that calculates a position of a portable device; an orientation computing unit that computes an orientation of the portable device based on the result in the detection of a direction of an orientation detection element outside of the portable device with a direction detection device that the portable device contains; and a relative angle calculation unit that decides a standard orientation of the portable device based on the calculation result of the orientation computing unit, and calculates an angle between the orientation of the portable device after the decision of the standard orientation and the standard orientation.
